(19) United States
(12) Patent Application Publication
(10) Pub. No.: US 2010/0138768 A1
(43) Pub. Date: Jun. 3, 2010

(54) Simplifying Configuration Of Multiple Display Units For Common Use

(75) Inventors: Amruta Satish Lonkar, Pune (IN); Imtiyaz Altafhussain Khatib, Pune (IN)

Correspondence Address: NVIDIA C/O MURABITO, HAO & BARNES LLP, TWO NORTH MARKET STREET, THIRD FLOOR, SAN JOSE, CA, 95113, US

(73) Assignee: NVIDIA Corporation, Santa Clara, CA (US)

(21) Appl. No.: 12/326,109

(22) Filed: Dec. 2, 2008

(51) Int. Cl. G06F 3/048

(52) U.S. Cl. 715/769; 715/764

(57) ABSTRACT

Simplifying configuration of multiple display units for a desired common use. In an embodiment, a user interface is provided to show the display units connected to a digital processing system. The user selects any desired set of display units as a group and, in response, the possible set of display modes (corresponding to the types of common uses) for that group is indicated. The user may select a desired display mode to cause images thereafter to be rendered on the group of display units in the selected display mode. When the group of display units is driven by multiple graphics processing units (GPUs), a user may be provided the option of selecting the specific ones of the potential processing modes in which the GPUs are operable together.

### BACKGROUND

1. Field of Disclosure

The present disclosure relates to computer generated displays and more specifically to simplifying configuration of multiple display units for common use.

2. Related Art

A display unit refers to a hardware unit connected to a digital processing system, which can present/render (visual) images on a display screen that forms part of the display unit. A display unit generally renders images based on the image/video/control data received from the digital processing system. Examples of display units include CRT monitors, LCD displays, etc.

Multiple display units are often connected to the same digital processing system for a common use, for example, to view a larger portion of the image (in the vertical and/or horizontal direction), to view the same image in different formats, etc. Accordingly, the multiple display units may be needed to be appropriately configured for the desired common use.

In one approach, configuration of the multiple display units requires a user to have an understanding of the architecture of the digital processing system as well as the common uses that are configurable for the multiple display units using the architecture. Such an approach is described below with respect to the user interfaces of FIGS. 1A-1D.

A user first specifies the physical arrangement of the display units using the interface shown in FIG. 1A. Thus, in FIG. 1A, the user is shown operating with an interface provided on a display unit, which is itself represented by icon 1 in the interface. The user is shown indicating that another display unit represented by icon 2 is physically located to the right of currently used display unit (represent by icon 1).

The user then configures the processors in the digital processing system based on the understanding of the architecture of the system using one of the interfaces shown in FIGS. 1B and 1C. FIG. 1B is used when the system contains multiple graphics processing units (GPU) driving different display units, and is used to indicate to such GPUs that support for multiple display units is desired. FIG. 1C is used if any of such GPUs support a scalable link interface (SLI) mode, which needs to be disabled for any common use to be enabled for the multiple display units.

The user then specifies the common use to which the multiple display units are to be configured using the interface shown in FIG. 1D. The common use that can be specified in FIG. 1D depends on the physical arrangement specified in FIG. 1A and the specific configuration of the processors specified in one of FIGS. 1B and 1C.

As may be observed, the user is required to perform several tasks manually and requires understanding of several internal details of the system, to configure multiple display units for a desired common use. Accordingly, it may be desirable that such configurations for common uses be simplified.

### BRIEF DESCRIPTION OF THE DRAWINGS

Example embodiments will be described with reference to the following accompanying drawings, which are described briefly below.

FIGS. 1A-1D together illustrate the manner in which a user is required to configure multiple display units for a desired common use in one prior approach.

FIG. 2 is a block diagram illustrating the details of a digital processing system in which several aspects of the present invention are operative by execution of appropriate software instructions.

FIG. 3 is a flow chart illustrating the manner in which the configuration of multiple display units for a common use is performed according to an aspect of the present invention.

FIG. 4A depicts a user interface showing display units connected to a digital processing system in one embodiment.

FIG. 4B illustrates the manner in which a user indicates a desired ones of the display units (shown in FIG. 4A) as a group in one embodiment.

FIG. 4C illustrates the manner in which a user selects a desired display mode from a possible set of display modes (in which user-indicated display units can be operated as a group) in one embodiment.

FIG. 4D illustrates the manner in which a user selects the processing mode of graphics processing units (GPU) for operating desired display units in a desired display mode in one embodiment.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION

Overview

An aspect of the present invention simplifies configuration of multiple display units for a desired common use. In an embodiment, a user interface is provided to show the display units connected to a digital processing system. The user selects any desired set of display units as a group and, in response, the possible set of display modes (corresponding to the types of common uses) for that group is indicated. The user may select a desired display mode to cause images thereafter to be rendered on the group of display units in the selected display mode.

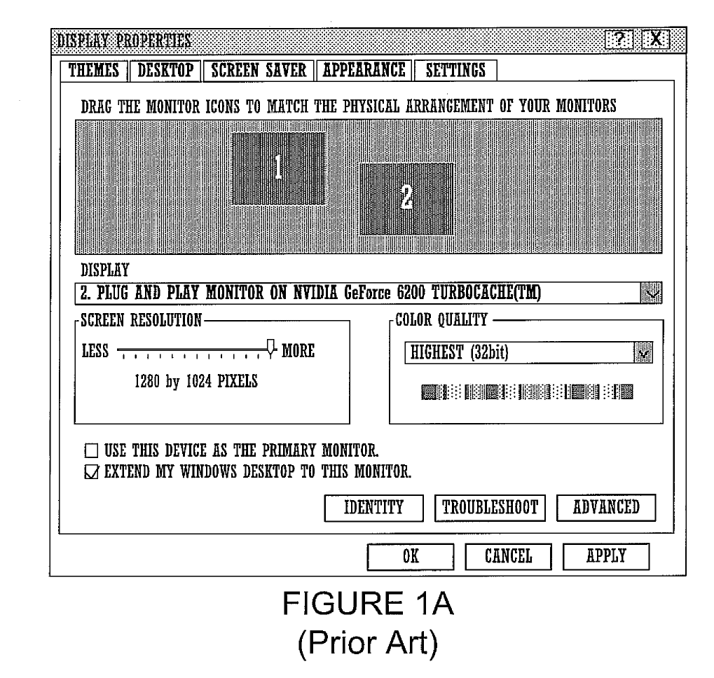

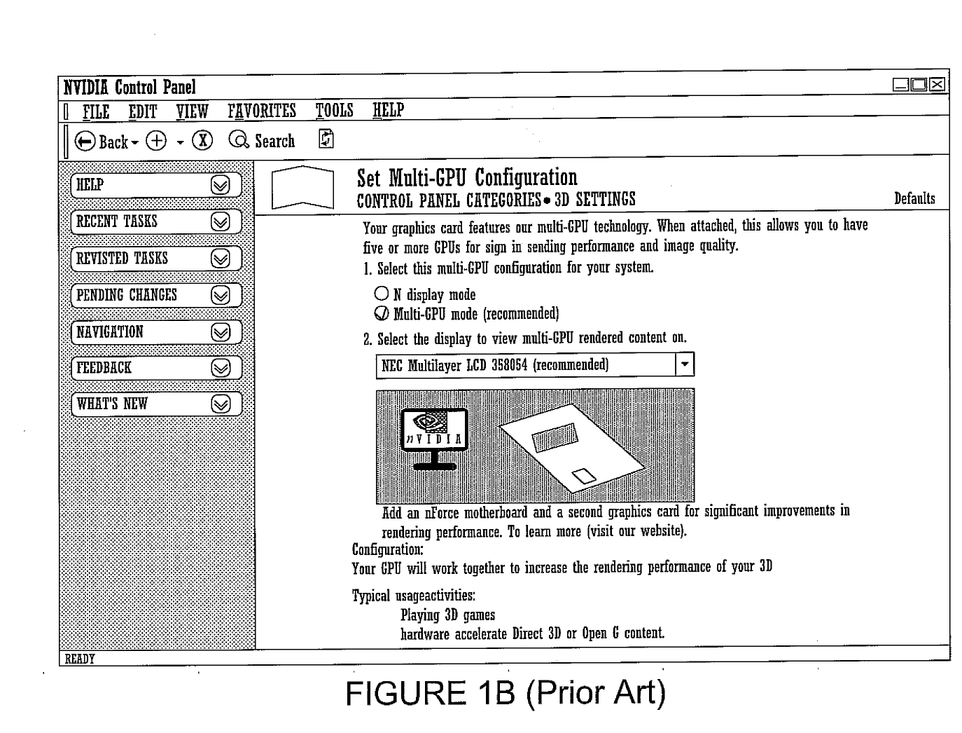

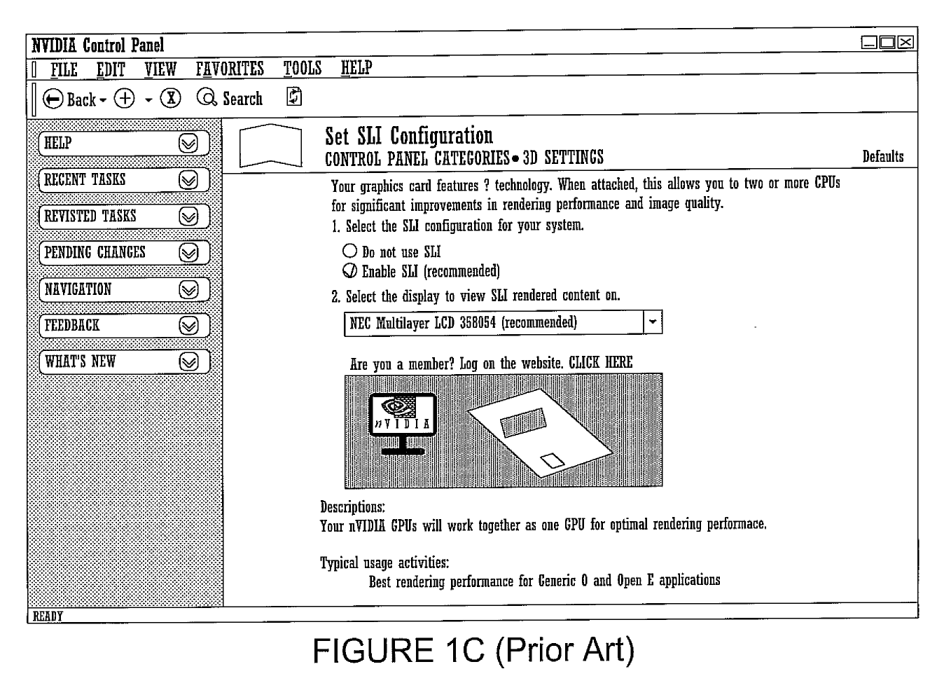

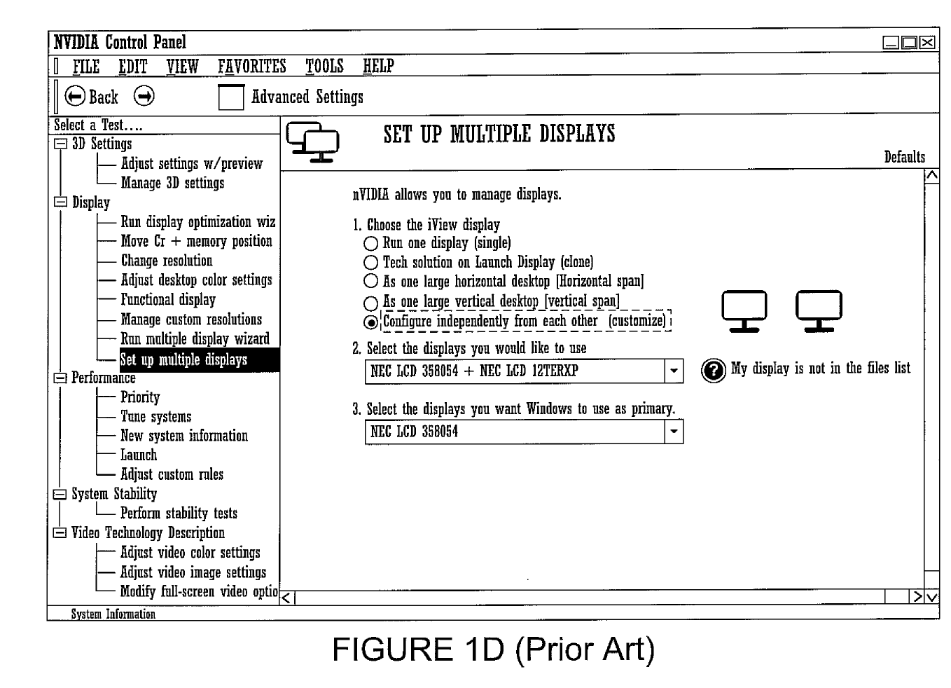

As the user is shielded from various internal details of the digital processing system, the configuration for desired common use is simplified (compared to at least the prior art embodiment described above with respect to FIGS. 1A-1D).

According to another aspect of the present invention, when a group of display units are driven by multiple graphics processing units (GPUs), the potential processing modes in which the GPUs are operable together, is displayed. The user may select a desired processing mode to cause the GPUs to operate in such a processing mode for supporting the operation of the above selected set of display units as a group in the selected display mode. Since the system guides the user in terms of the possible processing modes, the user interface is made more user-friendly.

Several aspects of the invention are described below with reference to examples for illustration. It should be understood that numerous specific details, relationships, and methods are set forth to provide a full understanding of the invention. For example, many of the functions units described in this specification have been labeled as modules/blocks in order to more particularly emphasize their implementation independence.

2. Digital Processing System

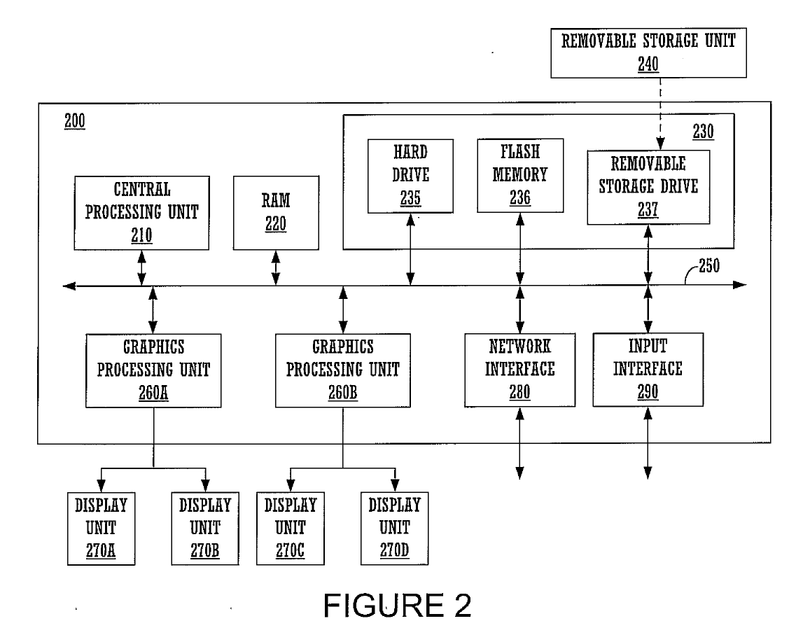

FIG. 2 is a block diagram illustrating the details of digital processing system 200 in which several aspects of the present invention are operative by execution of appropriate software instructions. Digital processing system 200 may contain one or more processors (such as a central processing unit (CPU) 210), random access memory (RAM) 220, secondary memory 230, graphics processing units (GPUs) 260A-260B (shown connected to display units 270A-270D), network interface 280, and input interface 290. All the components except display units 270A-270D may communicate with each other over communication path 250, which may contain several buses as is well known in the relevant arts. The components of FIG. 2 are described below in further detail.

CPU 210 may execute instructions stored in RAM 220 to provide several features of the present invention described in sections above. CPU 210 may contain multiple processing units, with each processing unit potentially being designed for a specific task, for example, to generate image data to be displayed. Alternatively, CPU 210 may contain only a single general-purpose processing unit. RAM 220 may receive instructions from secondary memory 230 using communication path 250. RAM also may store/provide data used during execution of the instructions.

Each of GPUs 260A-260B generates electrical signals (e.g., in RGB format) to the connected display units 270A-270D based on image data/instructions received from CPU 210. GPUs 260A-260B (operating individually or together) may render the received image data on the corresponding display units after performing complex processing of the received data. The image data received/ processed may form the basis for the user interfaces (including interaction with input/output devices) described below in selecting group of display units, display mode and processing mode, as well as displaying images thereafter.

GPUs are generally operable to perform in various processing modes, each processing mode indicating the manner of interaction/coupling between the GPUs and/or the manner of operation of each GPU in processing image data received from CPU 210. For example, in the scenario where the GPUs are from NVIDIA Corporation, the assignee of the subject patent application, the processing mode named Scalable Link Interface (SLI) indicates that the multiple GPUs are to be linked together to produce a single output (signal). Another processing mode “Hybrid Save Power” indicates that the multiple GPUs are to be operated together to reduce the total power consumed by system 200. Other GPUs may support other/different types of processing modes.

Each of display units 270A-270D contains a display screen to display the images defined by the display signals received from the corresponding GPU (and accordingly, a display unit may be viewed as being driven by the corresponding GPU). Display Units 270A-270B are shown connected to graphics processor 260A and accordingly display the images received from graphics processor 260A. Similarly, display units 270C-270D display the images received from graphics processor 260B. Any combination of the display units can be operated for a common use. One (270A) of the display units is considered a primary display unit, which is used to provide the various user interfaces of several aspects of the present invention, described below.

Input interface 290 may correspond to a keyboard and a pointing device (e.g., touch-pad, mouse) and may be used to provide various inputs. Network interface 280 provides connectivity to a network (e.g., using Internet Protocol), and may be used to communicate with other connected systems.

Secondary memory 230 may contain hard drive 235, flash memory 236, and removable storage drive 237. Secondary memory 230 may store the data and software instructions, which enable digital processing system 200 to provide several features in accordance with the present invention.

Some or all of the data and instructions may be provided on removable storage unit 240, and the data and instructions may be read and provided by removable storage drive 237 to CPU 210. Floppy drive, magnetic tape drive, CD-ROM drive, DVD Drive, Flash memory, removable memory chip (PCMCIA Card, EPROM) are examples of such removable storage drive 237.

Removable storage unit 240 may be implemented using medium and storage format compatible with removable storage drive 237 such that removable storage drive 237 can read the data and instructions. Thus, removable storage unit 240 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 240 or hard disk installed in hard drive 235. These computer program products are means for providing software to digital processing system 200. CPU 210 may retrieve the software instructions, and execute the instructions to provide various features of the present invention described below with examples.

In the following description, numerous specific details are provided such as examples of programming, software modules, user selections, network transactions, database queries, database structures, hardware modules, hardware circuits, hardware chips, etc., to provide a thorough understanding of embodiments of the invention.

It may be appreciated that a user may desire to configure display units 270A-270D for a common use, for example, to view a larger portion of an image in the horizontal/vertical direction. An aspect of the present invention simplifies the configuration of display units 270A-270D as described below with examples.

3. Configuring Multiple Display Units

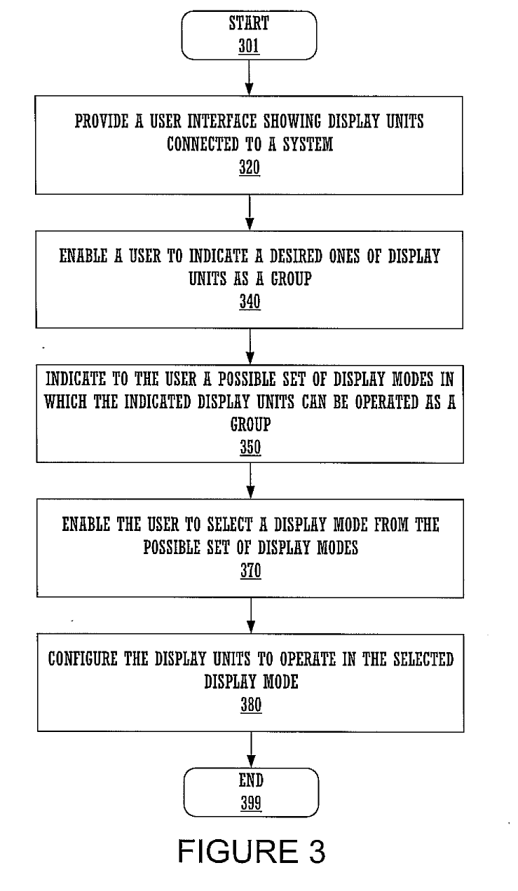

FIG. 3 is a flow chart illustrating the manner in which the configuration of multiple display units for a common use is performed according to an aspect of the present invention. The flowchart is described with respect to FIG. 2 merely for illustration. However, various features can be implemented in other environments also without departing from the scope and spirit of various aspects of the present invention, as will be apparent to one skilled in the relevant arts by reading the disclosure provided herein.

In addition, some of the steps may be performed in a different sequence than that depicted below, as suited in the specific environment, as will be apparent to one skilled in the relevant arts. Many of such implementations are contemplated to be covered by several aspects of the present invention. The flow chart begins in step 301, in which control immediately passes to step 320.

In step 320, CPU 210 provides a user interface showing display units 270A-270D connected to system 200. User interface generally entails displaying images and the ability to receive user inputs associated with specific portions (usually the representations of various components/entities, as described below) The user interface may be provided on one of display units 270A-270D in response to receiving a user indication. In one embodiment, the user interface is provided only on the primary display unit 270A.

Each of the display units may be shown using a corresponding representation, for example, as a graphical icon, in the user interface. In one embodiment described below, each display unit is represented as a corresponding rectangle icon. However, the display units may be represented using other/different icons/images based on the type (CRT monitor, LCD etc.), dimension (17 inch, 21 inch etc.) and other features of the display units, as will be apparent to one skilled in the relevant arts.

In step 340, CPU 210 enables a user to indicate desired ones of the display units as a group. The display units forming the group may be chosen to facilitate a common use according to the physical arrangement. For example, when a user desires to view a larger portion of an image in the horizontal direction, the user may indicate as the group two display units that are physically adjacent to each other in the horizontal direction.

The user may provide the indication using a keyboard or a pointer device connected to input interface 290. In one embodiment, the user drag and drops (using a pointer device) a first representation/icon representing a first display unit onto a second representation/icon representing a second display unit indicating that the first and second display units form a group. As is well known, a drag and drop operation is generally accomplished by selecting (clicking on) the first icon and moving the pointer device on to the second icon, while maintaining selection (keeping the clicked on state of the pointer device) of the first icon.

In step 350, CPU 210 indicates to the user a possible set (one or more) of display modes in which the indicated display units can be operated as a group. The set of display modes are provided in response to the user indicating the desired set of display units as a group (for common use). “In response to” implies that the user specifying the group causes the CPU 210 to determine possible set of common uses and indicate the determined set of common uses/display modes. The possible set of display modes may be provided to the user in an appropriate manner, for example, as a selection list, a selectable icon in a group of icons, etc.

Each display mode corresponds to type of common use for the indicated display units (as a group). For example, the display mode “horizontal span” corresponds to viewing of a larger portion of an image in a horizontal direction across multiple display units that are possibly physically adjacent to each other. Another display mode “clone” indicates that the same video/image output is to be displayed on all of the display units in the group. Other display modes may correspond to other common uses of multiple display units.

The possible set of display modes may be determined by CPU 210 based on one or more of factors such as the physical arrangement of the display units, the connection between the display units and the GPUs, the technology supported by each of GPUs/CPU, the operating system etc. The possible set of display modes corresponding to different combinations of operating system, technology supported and the number/type of display units for Graphic s Processing Units (GPUs) available from NVIDIA Corporation, the assignee of the subject patent application is shown in Appendix A.

It should be appreciated that much of this information is available internal to the digital processing system, and can thus be conveniently ascertained and used in accordance with several aspects of the present invention. Alternatively or in addition, some of the information may be entered once (e.g., which display units are connected to which GPUs, the physical arrangement of the display units) by an administrator, and thereafter be used by users during configuration of display units for different common uses, as needed in specific situations.

In step 370, CPU 210 enables the user to select a display mode from the possible set of display modes. The selected display mode may correspond to the user desired common use of the multiple display units. The selection may be performed using input devices connected to input interface 290, for example, using a pointer device to select the desired display mode in a selection list or the icon corresponding to the desired display mode in a selectable group of icons.

In step 380, CPU 210 configures the group of display units to operate in the selected display mode. Configuration requires the setting of appropriate locations (e.g., registers) with specific values consistent with the desired common use for the specified groups of display units. The configuration may be performed in a known way based on the type/number of graphics/general processors, the operating system, manner in which the display units are connected to the GPUs, etc., as will be apparent to one skilled in the relevant arts.

In an embodiment, CPU 210 first identifies the technologies supported by the GPUs, the display modes supported by the operating system, the manner of connection between display units and GPUs etc. CPU 210 then determines the values corresponding to pre-defined parameters/properties (controlling the operation of the display units/operating system/graphics processors) based on the identified information and the user selected display mode. The pre-defined parameters/properties are then set to the corresponding determined values (in the appropriate locations) to cause the group of display units to operate in the selected display mode. The flow chart ends in step 399.

Thus, a user is enabled to configure multiple display units for a desired common use by using simple operations such as drag and drop, list selection etc. in contrast to the complex set of operations to be performed in prior approaches, for example, as illustrated in FIGS. 1A-1D.

Accordingly, the configuration of multiple display units for a common use is simplified by the above described interface. The manner in which such an interface is provided in one embodiment is described below with examples.

4. Example Implementation

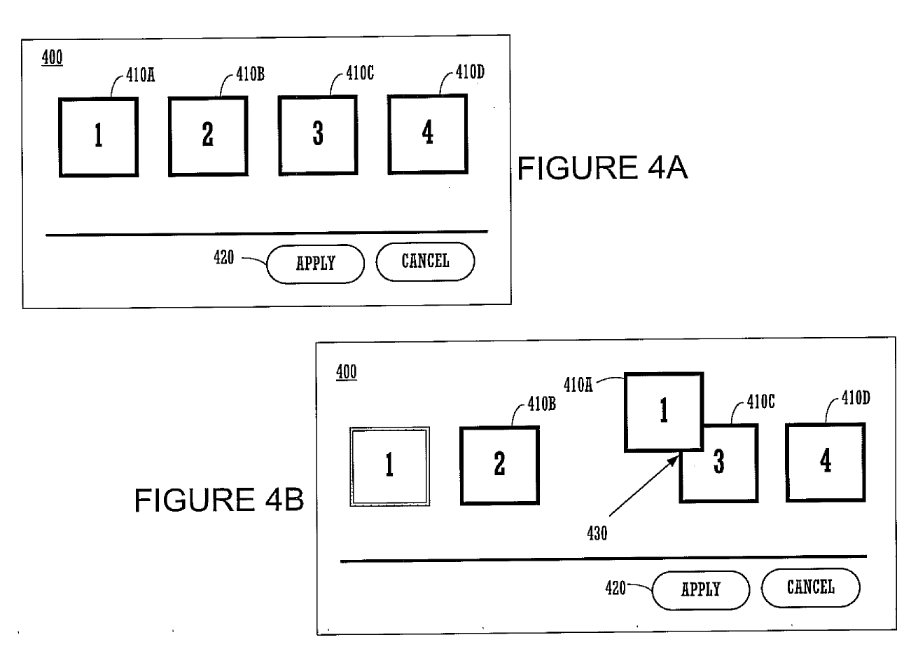

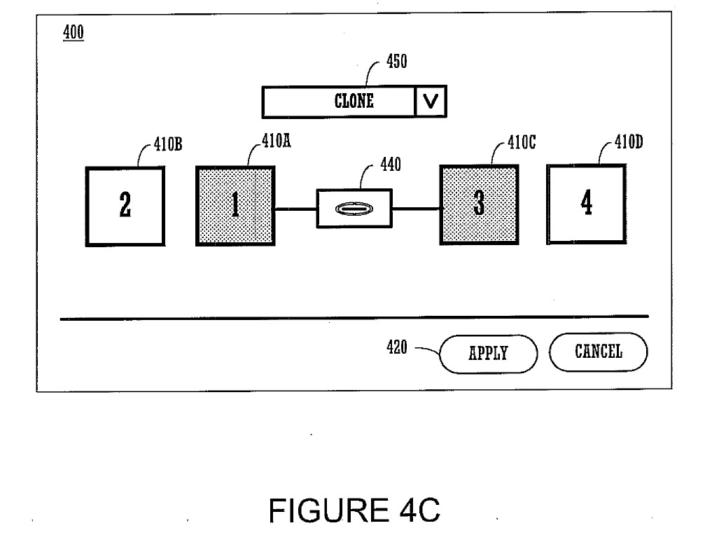

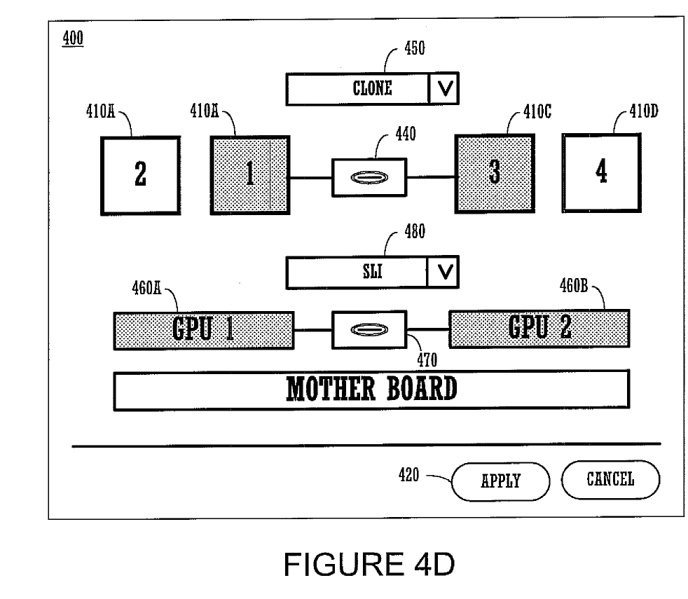

FIGS. 4A-4C together illustrates the manner in which the configuration of multiple display units for common use is enabled in one embodiment. Each of the Figures is described in detail below.

FIG. 4A depicts a user interface showing display units connected to a digital processing system (such as 200) in one embodiment. Display area 400 represents a portion of the user interface provided on a display unit (such as one of display units 270A-270D) associated with the digital process system (200). Each of icons 410A-410D represents corresponding display units (assumed to respectively be display units 270A-270D for convenience) connected to digital processing system 200.

Apply button 420 (labeled “Apply”) enables the user to indicate that that configuration specified in display area 400 is to be applied to the multiple display units. In one embodiment, the user is required to select/click apply button 420 only after performing all the required configurations (as described below). However, in other embodiments, the user may be required to select/click apply button 420 after performing each of the steps of FIG. 3.

FIG. 4B illustrates the manner in which a user indicates a desired ones of the display units (shown in display area 400 of FIG. 4A) as a group in one embodiment. Similar numbers are used to represent corresponding portions of FIGS. 4A, 4B, 4C and 4D and hence descriptions of such portions are not repeated for conciseness.

A user drags and drops (using a pointer device) the icon representing a display unit onto the icon representing another display unit indicating that the display units form a group (to facilitate a common use). Thus, 430 representing the drag and drop action of dragging icon 410A and dropping it on icon 410C indicates that the user desires to group the corresponding display units 270A and 270C.

In response to the drag and drop action 430, system 200 determines a possible set of display modes in which the indicated display units 270A and 270C can be operated as a group. The determined possible set of display units is then indicated to the user as described below.

FIG. 4C illustrates the manner in which a user selects a desired display mode from a possible set of display modes (in which user-indicated display units can be operated as a group) in one embodiment. Display area 400 of FIG. 4C is shown in response to drag and drop action 430 of FIG. 4B.

Icons 410A and 410C are shown adjacent to each other based on drag and drop action 430 performed by the user in the interface of FIG. 4B. Group icon 440 indicates that display units 270A and 270C (corresponding to the icons) are to be grouped together to facilitate a common use. Other types of group representations/icons, for example, a reactangle surrounding icons 410A and 410C, may be used to indicate the display units forming the group.

List box 450 provides a list of possible display modes in which display units 270A and 270C can be operated as a group. The list of display modes may include “Clone” for displaying the same images on both display units, “Horizontal Span” for displaying a larger portion of the image in the horizontal direction, “Vertical Span” for for displaying a larger portion of the image in the vertical direction, etc.

The value “Clone” shown in list box 450 represents the display mode selected by the user from the list of possible display modes provided in the list box. The user may now select/click apply button 420 to indicate that display units 270A-270D are to configured such that display units 270A and 270C operate in the selected “Clone” display mode.

In response to the user selecting/clicking apply button 420, digital processing system 200 configures the respective GPUs to cause display units 270A and 270C to operate in a “Clone” mode, thereby enabling the user to view the same images on the multiple display units. As described above, the configuration entails identifying the specific architecture of system 200, determining values of specific parameters/registers, and setting the specific parameters/registers to the determined values.

Thus, a user configures multiple display units for a desired common use by merrely indicating the common use/display mode for the desired display units. Though the above example is described with respect to groups of two display units, it may be appreciated groups of more than two display units may be similarly implemented, for example, by enabling a user to drag and drop more icons on the group icon to indicate that more display units are to be included in the same group.

Furthermore, it may be observed that the user does not indicate the specific manner of configuration of the underlying GPUs, operating system, display units etc. However, in some scenarios, for example, when the user is an expert user or an administrator, it may be desirable that the user be provided the ability to specify the manner of configuration of digital processing system 200 as described below with examples.

FIG. 4D illustrates the manner in which a user selects the processing mode of GPUs for operating desired display units in a desired display mode in one embodiment. Display area 400 of FIG. 4D may be provided as an advanced option to the user interface depicted in FIGS. 4A-4C. Alternatively, display area 400 of FIG. 4D may be displayed in response to user selecting the desired display mode (“Clone”) in display area 400 of FIG. 4C.

Icons 460A-460B represents corresponding graphics processing units (such as GPUs 260A-260B) executing on an underlying motherboard (shown as another icon) in digital processing system 200. Icons 460A-460B representing GPUs are shown connected by lines to one or more of icons 410A-410D representing the display units, indicating that there exists a physical connection between the graphical processor and the corresponding display unit. Thus, display units 270A-270B are shown connected to graphics processor 260A while display units 270C-270D are shown connected to graphics processor 260B (reflecting the environment of FIG. 2).

Link icon 470 indicates that GPUs 260A-260B are required to be operative together (in a tightly/loosely coupled manner) to enable display units 270A and 270C to be operated in the “Clone” display mode. The GPUs are required to be operative together since the grouped displays are physically connected to different GPUs and have to display the same output (“Clone”).

List box 480 provides a list of possible processing modes in which GPUs 260A-260B can be operated together. The possible set of processing modes may be determined based on the capabilities of/technologies supported by the GPUs, the manner of connection between the GPUs (general/dedicated bus), etc. The value “SLI” in list box 480 represents a specific processing mode selected by a user from the provided list of possible processing modes.

The user may now select/click apply button 420 to indicate that the display units/GPUs are to be configured as per the selections specified in display area 400. In response to the clicking of apply button 420, digital processing system 200 configures GPUs 260A and 260B to work together in “SLI” modes to support the operation of display units 270A and 270C as a group in “Clone” mode. Configuration of the GPUs generally entails setting specific registers contained in the GPU to appropriate values corresponding to the processing mode selected by the user.

It may be appreciated that after the configuration, the GPUs in systems 200 render images on the multiple display units according to the user selected display mode. In the above described example, GPUs 260A-260B work together in “SLI” mode to render the same images on both display units 270A and 270C corresponding to the Clone display mode. The images rendered on the displayed units may be based on the image data received from the CPU of the digital processing system.

5. Conclusion

While various embodiments of the present invention have been described above, it should be understood that they have been presented by way of example only, and not limitation. Thus, the breadth and scope of the present invention should not be limited by any of the above described exemplary embodiments, but should be defined only in accordance with the following claims and their equivalents.

It should be understood that the figures and/or screen shots illustrated in the attachments highlighting the functionality and advantages of the present invention are presented for example purposes only. The present invention is sufficiently flexible and configurable, such that it may be utilized in ways other than that shown in the accompanying figures.

Further, reference throughout this specification to “one embodiment”, “an embodiment”, or similar language means that a particular feature, structure, or characteristic described in connection with the embodiment is included in at least one embodiment of the present invention. Thus, appearances of the phrases “in one embodiment”, “in an embodiment” and similar language throughout this specification may, but do not necessarily, all refer to the same embodiment.

Furthermore, the described features, structures, or characteristics of the invention may be combined in any suitable manner in one or more embodiments.

Further, the purpose of the following Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

### Appendix A

| | Setup | | |
|---|---|---|---|
| | Number of Display | Display Modes for | Display Modes for |
| Technology | Units | Windows XP | Windows Vista |
| Single Graphics | Single display unit | Single | Single |
| Processing Unit | Multiple display units | Single | Single |
| (GPU) | | Clone | Clone |
| | | Dual View | Dual View |
| | | Horizontal span | |
| | | Vertical span | |
| Multiple GPU | Single display unit | Single | Single |
| | Multiple display units | Single | Single |
| | | Clone | Clone |
| | | Dual View | Dual View |
| | | Horizontal span | |
| | | Vertical span | |
| Multiple GPU, | Single display unit | Single | Single |
| SLI Enabled | Multiple display units | Single | Single |
| Multiple GPU, | Single display unit | Single | Single |
| SLI Disabled | Multiple display units | Single | Single |
| | connected to GPU1 | Clone | Clone |
| | | Dual View | Dual View |
| | | Horizontal span | |
| | | Vertical span | |
| | Multiple display units | Single | Single |
| | connected to GPU2 | Clone | Clone |
| | | Dual View | Dual View |
| | | Horizontal span | |
| | | Vertical span | |
| Multiple GPU, | Single display unit | Single | Single |
| Hybrid Save Power | connected to mGPU | | |
| | Single display unit | NA | NA |
| | connected to dGPU | | |
| | Multiple display units | Single | Single |
| | connected to mGPU | Clone | Clone |
| | | Dual View | Dual View |
| | | Horizontal span | |
| | | Vertical span | |
| | Multiple display units | NA | NA |
| | connected to dGPU | | |
| Multiple GPU, | Single display unit | Single | Single |
| Hybrid Boost | connected to mGPU | | |
| Performance | Single display unit | NA | NA |
| | connected to dGPU | | |
| | Multiple display units | Single | Single |
| | connected to mGPU | Clone | Clone |
| | | Dual View | Dual View |
| | | Horizontal span | |
| | | Vertical span | |
| | Multiple display units | Single | Single |
| | connected to dGPU | Clone | Clone |
| | | Dual View | Dual View |
| | | Horizontal span | |
| | | Vertical span | |
| Multiple GPU, | Single display unit | Single | Single |
| Hybrid Additional | Multiple display units | Single | Single |
| Displays | connected to mGPU | Clone | Clone |
| | | Dual View | Dual View |
| | | Horizontal span | |
| | | Vertical span | |
| | Multiple display units | Single | Single |
| | connected to dGPU | Clone | Clone |
| | | Dual View | Dual View |
| | | Horizontal span | |
| | | Vertical span | |

What is claimed is:

1. A method of enabling a user to configure desired ones of a plurality of display units for a common use, said method being performed in a digital processing system to which said plurality of display units are connected, said method comprising:
displaying a corresponding representation of each of said plurality of display units on a first display unit, said first display unit being contained in said plurality of display units;
enabling said user to specify a set of display units as a group based on corresponding displayed representations, said set of display units being contained in said plurality of display units;
indicating a set of display modes in which said set of display units can be operated together as said group in response to said user specifying said group, wherein each display mode corresponds to a corresponding type of common use;
receiving from said user an indication representing a display mode selected from said set of display modes; and
configuring said set of display units for operation as said group in said display mode.

2. The method of claim 1, wherein said enabling comprises:
receiving data indicating that a first representation has been dragged and dropped onto a second representation, wherein said first representation corresponds to a second display unit and said second representation corresponds to a third display unit, wherein said second display unit and said third display unit are contained in said plurality of display units; and
forming said group to contain said second display unit and said third display unit.

3. The method of claim 2, further comprising:
displaying a group representation connecting said first representation and said second representation to indicate that said second display unit and said third display unit form said group;
receiving a second data indicating that a third representation has been dragged and dropped onto said group representation, wherein said third representation corresponds to a fourth display unit contained in said plurality of display units; and
including said fourth display unit in said group.

4. The method of claim 2, wherein said indicating comprises listing said set of display modes on said first display unit, wherein said indication is generated based on selection from said listing.

5. The method of claim 4, wherein said listing is in the form of a list box, wherein said user operates said list box to select said display mode.

6. The method of claim 4, wherein said listing is in the form of a corresponding number of icons representing said set of display modes, wherein said user clicks the corresponding icon to select said display mode.

7. The method of claim 2, further comprising:
displaying a corresponding representation of each of a plurality of graphical processing units (GPU) on said first display unit, wherein said plurality of GPUs are contained in said digital processing system and each of said plurality of display units is driven by one of said plurality of GPUs;
indicating a set of processing modes in which a set of GPUs driving said set of display units are operable to support said group in said display mode, said set of GPUs being contained in said plurality of GPUs; and
receiving from said user a second indication representing a processing mode selected from said set of processing modes,
wherein said configuring configures said set of GPUs in said processing mode to support the operation of said set of display units as said group in said display mode.

8. The method of claim 7, further comprising displaying lines connecting the representations of said plurality of GPUs with the representations of said plurality of display units to indicate which of said plurality of GPUs drives which of said plurality of display units.

9. The method of claim 8, wherein said indicating of said set of processing modes comprises listing said set of processing modes in the form of a second list box, wherein said user operates said second list box to select said processing mode, thereby generating said second indication.

10. The method of claim 9, wherein a first line indicates that said second display unit is driven by a first GPU and a second line indicates that said third display unit is driven by a second GPU, said first GPU and said second GPU being contained in said plurality of GPUs, said method further comprising:
displaying a link representation connecting the representations of said first GPU and said second GPU to indicate that said first GPU and said second GPU are operable together in driving said second display unit and said third display unit,
wherein said second list box is displayed associated with said link representation.

11. A computer readable medium storing one or more sequences of instructions causing a digital processing system to enable a user to configure desired ones of a plurality of display units for a common use, wherein said plurality of display units are connected to said digital processing system, wherein execution of said one or more sequences of instructions by one or more processors contained in said digital processing system causes said digital processing system to perform the actions of:
displaying a corresponding representation of each of said plurality of display units on a first display unit, said first display unit being contained in said plurality of display units;
enabling said user to specify a set of display units as a group based on corresponding displayed representations, said set of display units being contained in said plurality of display units;
indicating a set of display modes in which said set of display units can be operated together as said group, wherein each display mode corresponds to a corresponding type of common use;
receiving from said user an indication representing a display mode selected from said set of display modes; and
configuring said set of display units for operation as said group in said display mode.

12. The computer readable medium of claim 11, wherein said enabling comprises one or more instructions for:
receiving data indicating that a first representation has been dragged and dropped onto a second representation, wherein said first representation corresponds to a second display unit and said second representation corresponds to a third display unit, wherein said second display unit and said third display unit are contained in said plurality of display units; and
forming said group to contain said second display unit and said third display unit.

13. The computer readable medium of claim 12, further comprising one or more instructions for:
displaying a group representation connecting said first representation and said second representation to indicate that said second display unit and said third display unit form said group;
receiving a second data indicating that a third representation has been dragged and dropped onto said group representation, wherein said third representation corresponds to a fourth display unit contained in said plurality of display units; and
including said fourth display unit in said group.

14. The computer readable medium of claim 12, further comprising one or more instructions for:
displaying a corresponding representation of each of a plurality of graphical processing units (GPU) on said first display unit, wherein said plurality of GPUs are contained in said digital processing system and each of said plurality of display units is driven by one of said plurality of GPUs;
displaying lines connecting the representations of said plurality of GPUs with the representations of said plurality of display units to indicate which of said plurality of GPUs drives which of said plurality of display units;
indicating a set of processing modes in which a set of GPUs driving said set of display units are operable to support said group in said display mode, said set of GPUs being contained in said plurality of GPUs; and
receiving from said user a second indication representing a processing mode selected from said set of processing modes,
wherein said configuring configures said set of GPUs in said processing mode to support the operation of said set of display units as said group in said display mode.

15. The computer readable medium of claim 14, wherein a first line indicates that said second display unit is driven by a first GPU and a second line indicates that said third display unit is driven by a second GPU, said first GPU and said second GPU being contained in said plurality of GPUs, further comprising one or more instructions for:
displaying a link representation connecting the representations of said first GPU and said second GPU to indicate that said first GPU and said second GPU are operable together in driving said second display unit and said third display unit,
wherein said indicating of said set of processing modes comprises listing said set of processing modes in the form of a second list box associated with said link representation, wherein said user operates said second list box to select said processing mode, thereby generating said second indication.

16. A digital processing system comprising:
a central processing unit (CPU) to generate image data; and
one or more graphics processing units (GPU) to drive a plurality of display units connected to said digital processing system to display a sequence of images based on said image data, said CPU operable to:
display a corresponding representation of each of said plurality of display units on a first display unit, said first display unit being contained in said plurality of display units;
enable a user to specify a set of display units as a group based on corresponding displayed representations, said set of display units being contained in said plurality of display units;
indicate a set of display modes in which said set of display units can be operated together as said group, wherein each display mode corresponds to a corresponding type of common use;
receive from said user an indication representing a display mode selected from said set of display modes; and
configure said set of display units for operation as said group in said display mode,
wherein a set of images displayed after said configuration are rendered on said set of display units according to said display mode, said set of images being contained in said sequence of images.

17. The digital processing system of claim 16, to perform said enabling, said CPU is further operable to:
receive data indicating that a first representation has been dragged and dropped onto a second representation, wherein said first representation corresponds to a second display unit and said second representation corresponds to a third display unit, wherein said second display unit and said third display unit are contained in said plurality of display units; and
form said group to contain said second display unit and said third display unit.

18. The digital processing system of claim 17, wherein CPU is further operable to:
display a group representation connecting said first representation and said second representation to indicate that said second display unit and said third display unit form said group;
receive a second data indicating that a third representation has been dragged and dropped onto said group representation, wherein said third representation corresponds to a fourth display unit contained in said plurality of display units; and
include said fourth display unit in said group.

19. The digital processing system of claim 17, wherein said one or more GPUs include a plurality of GPUs, wherein said CPU is further operable to:
display a corresponding representation of each of said plurality of GPUs on said first display unit;
display lines connecting the representations of said plurality of GPUs with the representations of said plurality of display units to indicate which of said plurality of GPUs drives which of said plurality of display units;
indicate a set of processing modes in which a set of GPUs driving said set of display units are operable to support said group in said display mode, said set of GPUs being contained in said plurality of GPUs; and
receive from said user a second indication representing a processing mode selected from said set of processing modes,
wherein said CPU configures said set of GPUs in said processing mode to support the operation of said set of display units as said group in said display mode.

20. The digital processing system of claim 19, wherein a first line indicates that said second display unit is driven by a first GPU and a second line indicates that said third display unit is driven by a second GPU, said first GPU and said second GPU being contained in said plurality of GPUs, said CPU further operable to:
display a link representation connecting the representations of said first GPU and said second GPU to indicate that said first GPU and said second GPU are operable together in driving said second display unit and said third display unit,
wherein said CPU indicating of said set of processing modes comprises listing said set of processing modes in the form of a second list box associated with said link representation, wherein said user operates said second list box to select said processing mode, thereby generating said second indication.
